(19) United States
(12) Patent Application Publication
(10) Pub. No.: US 2004/0105130 A1
(43) Pub. Date: Jun. 3, 2004

(54) [SCAN DEVICE AND A METHOD FOR ENHACING THE LIFE OF THE SAME]

(76) Inventor: Chin-Chung Lien, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,328

(22) Filed: Sep. 23, 2003

(30) Foreign Application Priority Data
Oct. 25, 2002 (TW) 91125113

(51) Int. Cl. G02B 26/08; H04N 1/04

(52) U.S. Cl. 358/406; 359/196; 358/475

(57) ABSTRACT

A scan device and a method for enhancing the life of the same are provided. The scan device comprises a scan chassis, a random selecting device, a brightness judging device and a chart. There are many lamps in the scan chassis, and each one of the lamps can provide a light with a predetermined brightness to the document. The random selecting device, which can randomly choose to turn on one of the lamps, is electrically connected to the scan chassis. The brightness judging device is electrically connected to the scan chassis. The chart is disposed above the scan chassis. By turning on one of the lamps randomly, the life of the scan device is enhanced. After a lamp fails, some or all of the other lamps are turned on so as to obtain a light with enough brightness and to further enhance the life of the scan device.

### CROSS REFERENCE TO RELATED APPLICATIONS

This application claims the priority benefit of Taiwan application serial no. 91125113, filed Oct. 25, 2002.

### BACKGROUND OF INVENTION

1. Field of Invention

The present invention generally relates to a scan device and a method thereof, and more particularly, to a scan device and a method for enhancing the life of same.

2. Description of Related Art

Accompanying the great enhancement of computer performance and the intensive development of Internet and multimedia techniques, besides using the digital camera (DC) to capture an image, other related documents or photos all extract the analog image from the text or picture by using the image input operation of an optical scanner, and the analog image is converted into a digital signal for output, so as to perform the operations of displaying, OCR (Optical Character Recognition), editing, storing, and output on the computer or other electronic product.

In the optical scanner, for example, in the flat scanner, the scan principle is that a light source is used to generate a light and the light is emitted to the object to be scanned, so that after the light is reflected or transmitted from the object to be scanned, the light forms an image on an image capturing device after it is reflected from multiple sets of the reflection mirrors and focused by an optical lens.

FIG. 1 schematically shows a diagram of a conventional light source module disposed on a scan chassis. Referring to FIG. 1, the scan chassis 100 is suitable for scanning a document 10, and the scan chassis 100 comprises a chassis cover 110, a light source module 120, a reflection mirrors set 130, an optical lens set 140, and an image capturing device 150. The light source module 120 comprises a lamp holder 122 and a lamp 124. Wherein, the lamp 124 is disposed inside the lamp holder 122, and the light source module 120 is disposed on the chassis cover 110. Further, the reflection mirror set 130 is disposed inside the chassis cover 110, and it is disposed on the light path behind the document 10. Moreover, the optical lens set 140 is disposed inside the chassis cover 110, and it is disposed on the light path behind the reflection mirror set 130. The image capturing device 150 is such as a CCD (Charge Coupled Device), and it is disposed inside the chassis cover 110 on a location in the light path behind the optical lens 140.

The light emitted from the lamp 124 emits onto the document 10, and the light enters into the chassis cover 110 via an opening 112 cut on the chassis cover 110 after it is reflected from the document 10, and the light finally forms an image on the image capturing device 150 after it is focused by the optical lens 140.

To be noted, the operation of the scan chassis is mainly limited by the life of the lamp. Normally, a general lamp fails after it has been used for about 10,000 hours (i.e. the brightness of the lamp degrades to 50% of the brightness of the original lamp at that time). However, the operation limit of other mechanical or electronic components on the scan chassis is much longer than the life of the lamp. Therefore, it causes a great waste if the scan chassis is directly replaced. In order to enhance the life of the scan chassis, there are two methods proposed by the prior art: (1) Using a long life lamp, such as a Cold Cathode Fluorescent Lamp (CCFL) so that a rather longer life can be obtained, however, using the long life lamp increases the cost and the enhanced life is quite limited. (2) Reducing the current flowing through the lamp, so that a longer life can be obtained, however, reducing the current flowing through the lamp decreases the brightness of the lamp and generates unstable problems such as the lamp flickering and thus directly impacts the scanning quality.

### SUMMARY OF INVENTION

To solve the problems mentioned above, the object of the present invention is to provide a scan device and a method for enhancing the life of the same, so as to significantly increase the life of the scan device.

Based on the object mentioned above, the present invention provides a scan device that is suitable for scanning a document. The scan device comprises a scan chassis, a random selecting device, a brightness judging device, and a chart. Wherein, the scan chassis comprises a chassis cover, a plurality of light source modules, a reflection mirror set, an optical lens, and an image capturing device. The light source modules are disposed on the chassis cover, and each of the light source modules comprises a lamp holder and a lamp. Further, each lamp is disposed in the corresponding lamp holder, and each lamp can provide a light with a predetermined brightness to the document. The reflection mirror set is disposed inside the chassis cover, and located in the light path behind the document. The optical lens is disposed inside the chassis cover, and located in the light path behind the reflection mirror set. The image capturing device is also disposed inside the chassis cover, and located in the light path behind the optical lens. Further, the random selecting device electrically connects to the scan chassis, so as to randomly select and turn on one of the lamps in the scan chassis. Furthermore, the brightness judging device also electrically connects to the scan chassis. The chart is disposed above the scan chassis.

Similarly, based on the same object mentioned above, the present invention further provides a scan device that is suitable for scanning a document. The scan device comprises a scan chassis, a random selecting device, a brightness judging device, and a chart. Wherein, the scan chassis comprises a chassis cover, at least one light source module, a reflection mirror set, an optical lens, and an image capturing device. The light source module is disposed on the chassis cover, and the light source module comprises a lamp holder and a plurality of lamps. Further, the lamps are disposed in the lamp holder, and each lamp can provide a light with a predetermined brightness to the document. The reflection mirror set is disposed inside the chassis cover, and located in the light path behind the document. The optical lens is disposed inside the chassis cover, and located in the light path behind the reflection mirror set. The image capturing device is also disposed inside the chassis cover, and located in the light path behind the optical lens. Further, the random selecting device electrically connects to the scan chassis, so as to randomly select and turn on one of the lamps in the scan chassis. Furthermore, the brightness judging device also electrically connects to the scan chassis. The chart is disposed above the scan chassis.

Further, the scan chassis has an opening, and the light reflected from the document arrives at the reflection mirror set via the opening. Further, the image capturing device is such as a CCD.

Similarly, based on the same object mentioned above, the present invention provides a method for enhancing the life of a scan device. At first, a scan device is provided, wherein the scan device comprises a plurality of lamps, a reflection mirror set, an optical lens set, and an image capturing device, wherein each of the lamps can provide a light with a predetermined brightness to the document. Then, one of the lamps is randomly selected and turned on.

Similarly, based on the same object mentioned above, the present invention further provides a method for enhancing the life of a scan device. At first, a scan device is provided, wherein the scan device comprises a first lamp, a second lamp, a reflection mirror set, an optical lens set, and an image capturing device. Wherein, the first lamp and the second lamp can provide a light with a predetermined brightness to the document. Then, the first lamp is turned on and a chart is scanned, so as to obtain a first scanning result. Then, it is determined whether the brightness of the first scanning result is higher than a predetermined value or not. If it is, the scanning document is started. Otherwise, when the brightness of the scanning result is lower than the predetermined value, the first lamp is turned off and the second lamp is turned on.

Then, after the second lamp is turned on, the chart is scanned so as to obtain a second scanning result. Then, it is determined whether the brightness of the second scanning result is higher than the predetermined value or not. If it is, the scanning of the document is started. Otherwise, when the brightness of the scanning result is lower than the predetermined value, the first lamp and the second lamp are turned on simultaneously.

Then, after the first lamp and the second lamp are turned on simultaneously, the chart is scanned so as to obtain a third scanning result. Finally, it is determined whether the brightness of the third scanning result is higher than the predetermined value or not. If it is, the scanning of the document is started. Otherwise, when the brightness of the scanning result is lower than the predetermined value, the user is notified to replace the first lamp and the second lamp.

Similarly, based on the same object mentioned above, the present invention further provides a method for enhancing the life of scan device. At first, a scan device is provided, wherein the scan device comprises a plurality of lamps, a reflection mirror set, an optical lens set, and an image capturing device, wherein each of the lamps can provide a light with a predetermined brightness to the document. Then, one of the lamps is randomly selected and turned on. A chart is scanned so as to obtain a scanning result. It is determined whether the brightness of the scanning result is higher than a predetermined value or not. If it is, the scanning document is started. Otherwise, when the brightness of the scanning result is lower than the predetermined value, the other lamp is selected and turned on.

Further, when the brightness of the scanning result is lower than the predetermined value, a step of scanning the chart so as to obtain a scanning result and determining whether the brightness of the scanning result is higher than the predetermined value or not is repeatedly performed.

Finally, when all lamps are selected and all brightness of the scanning results obtained from using the lamps to scan are lower than the predetermined value, all lamps can be turned on simultaneously or only some lamps are turned on.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a diagram of a conventional light source module disposed on a scan chassis.

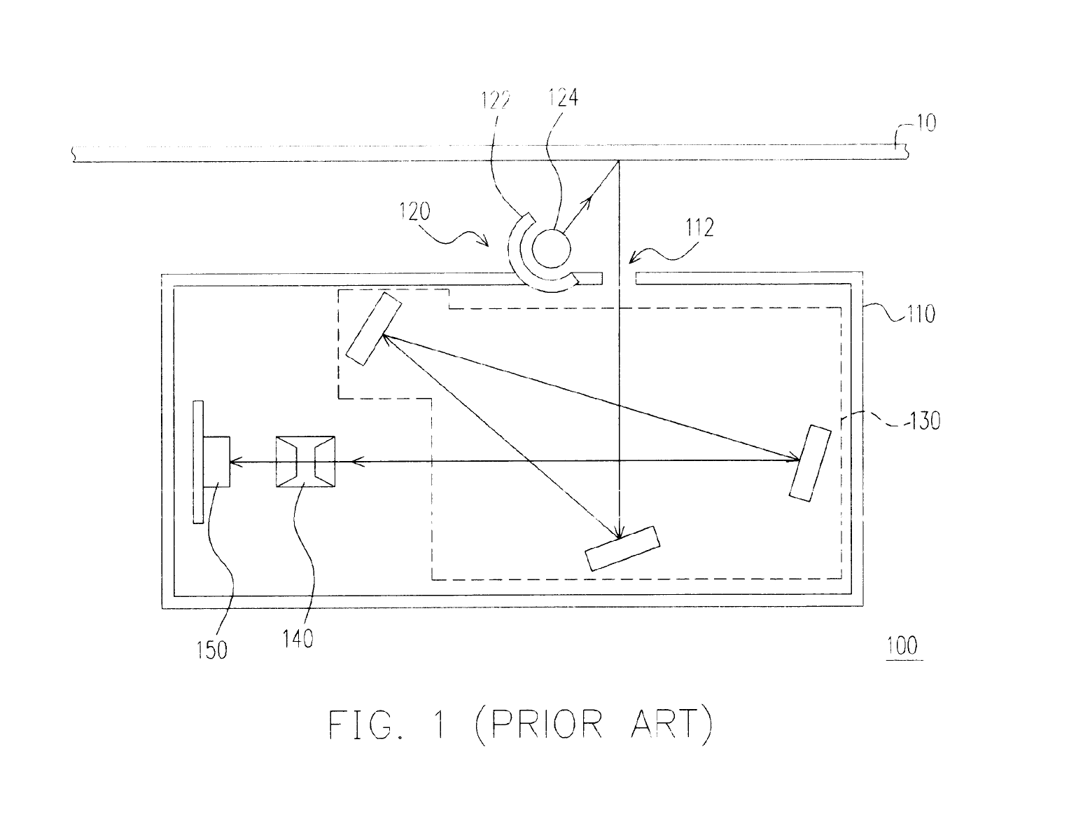

FIG. 2 schematically shows a diagram of a scan device of a preferred embodiment according to the present invention.

FIG. 3 schematically shows a diagram of a light source module disposed on a scan chassis of a preferred embodiment according to the present invention.

FIG. 4 schematically shows a flow chart of a method for turning on the light source module of a preferred embodiment according to the present invention.

### DETAILED DESCRIPTION

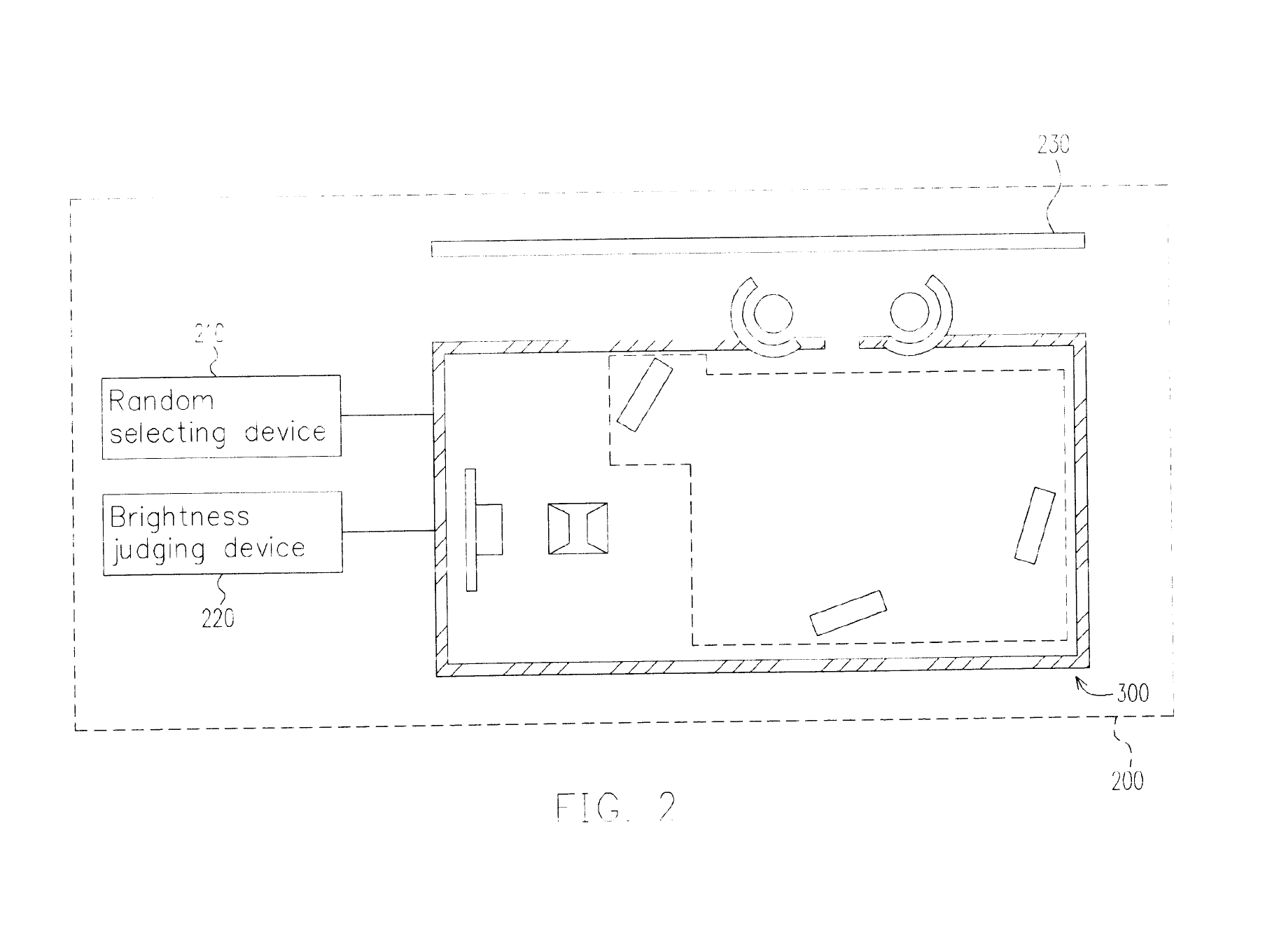

FIG. 2 schematically shows a diagram of a scan device of a preferred embodiment according to the present invention. The scan device 200 is suitable for scanning a document, and the scan device 200 comprises a random selecting device 210, a brightness judging device 220, a chart 230, and a scan chassis 300. Wherein, the random selecting device 210 electrically connects to the scan chassis 300, and the random selecting device 210 is used to randomly select and turn on one of the plurality of lamps. The brightness judging device 220 also electrically connects to the scan chassis 300, and the brightness judging device 220 is used to judge a difference between the brightness of the scanning result and a predetermined value. The chart 230 is disposed above the scan chassis 300, for the scan chassis 300 to scan and obtain the scanning result.

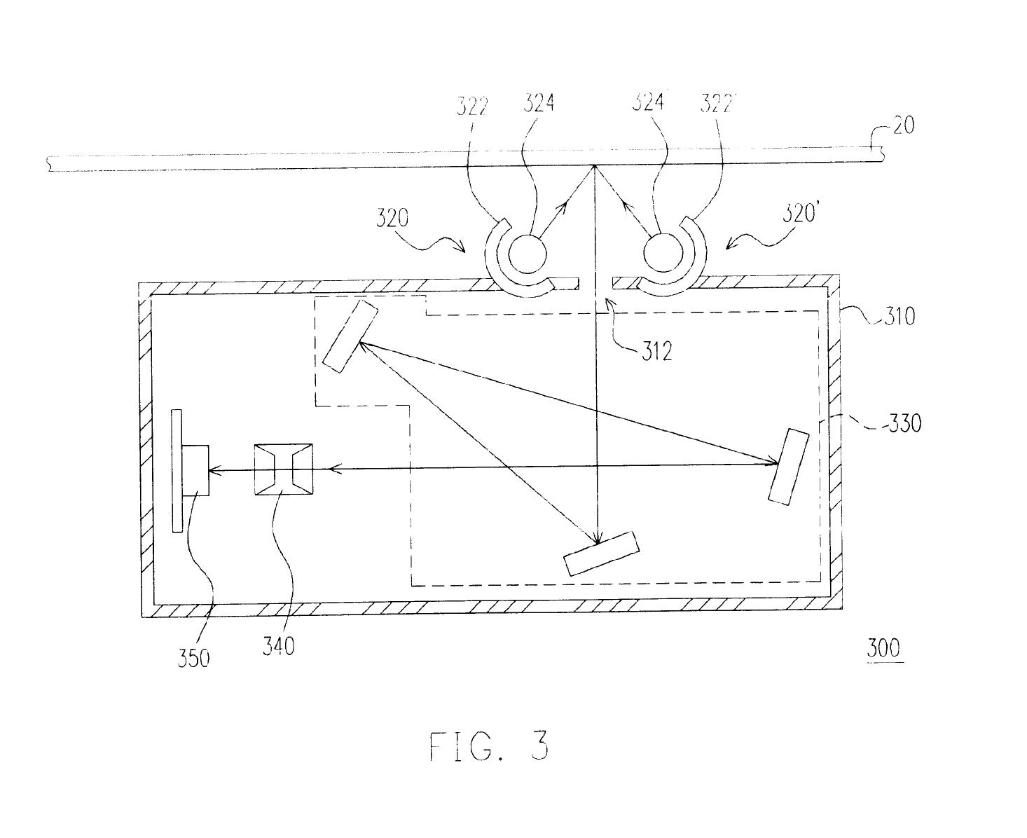

FIG. 3 schematically shows a diagram of a light source module disposed on a scan chassis of a preferred embodiment according to the present invention. The scan chassis 300 comprises a chassis cover 310, two light source modules 320, 320′, a reflection mirror set 330, an optical lens set 340, and an image capturing device 350. These two light source modules 320, 320′ are disposed on the scan chassis 310, and are composed of a lamp holder 322, 322′ and a first lamp 324 and a second lamp 324′, respectively, wherein the first lamp 324 is disposed inside the lamp holder 322, and the second lamp 324′ is disposed inside the lamp holder 322′. Further, the first lamp 324 and the second lamp 324′ can provide a light with a predetermined brightness to the document 20. Moreover, the reflection mirror set 330 is disposed inside the chassis cover 310, and located in the light path behind the document 20. The optical lens set 340 is disposed inside the chassis cover 310, and located in the light path behind the reflection mirror set 330. The image capturing device 350 is such as a CCD, and is located inside the chassis cover 310. Furthermore, the image capturing device 350 is located in the light path behind the optical lens set 340.

Then, the light emitted from the first lamp 324 and the second lamp 324′ emits onto the document 20, and the light enters into the chassis cover 310 via an opening 312 cut in the chassis cover 310 after it is reflected from the document 20, and finally forms an image on the image capturing device 350 after it is focused by the optical lens 340.

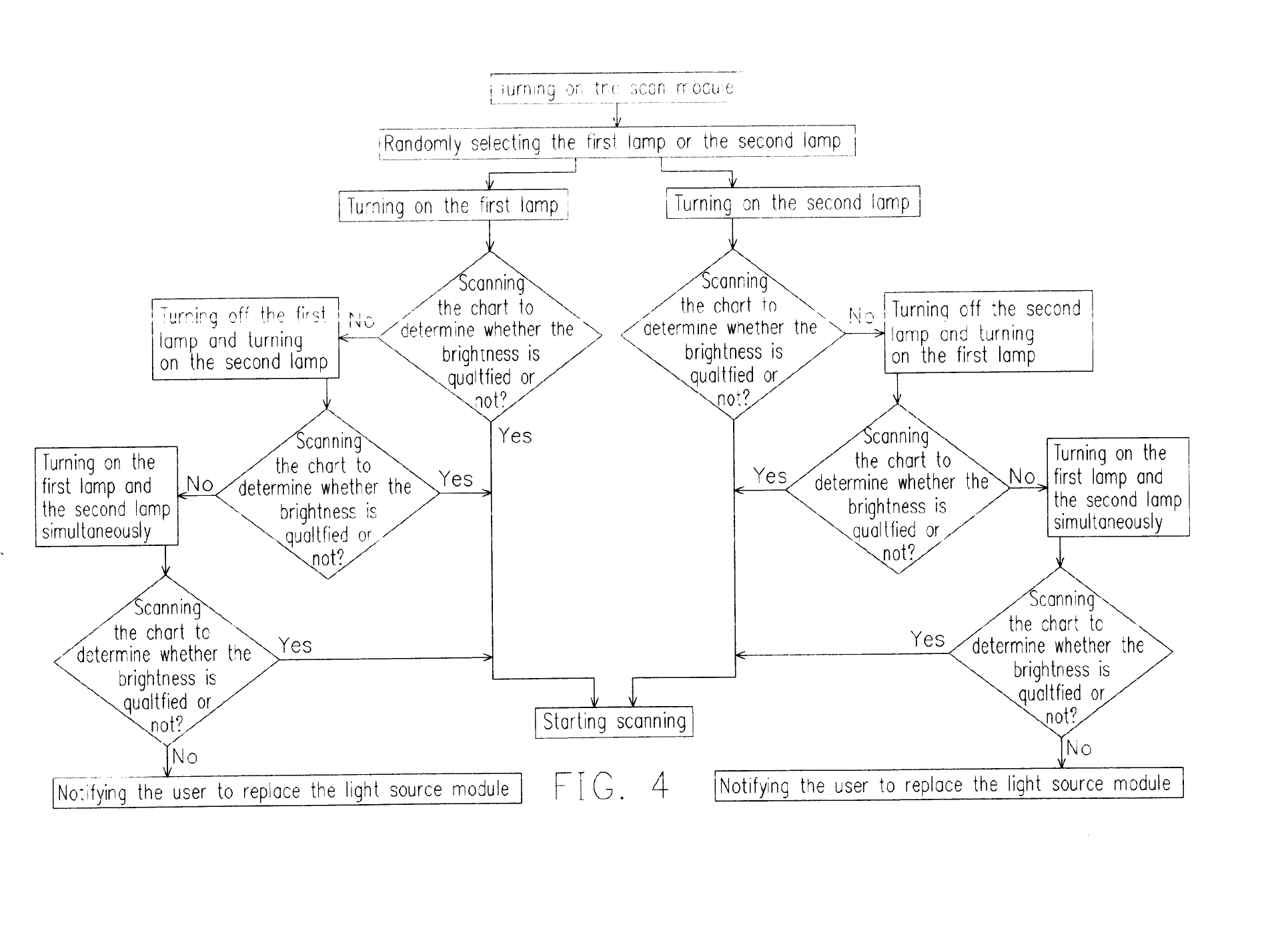

FIG. 4 schematically shows a flow chart of a method for turning on the light source module of a preferred embodiment according to the present invention. When the scan device is turned on, the scan device selectively turns on the first lamp or the second lamp with equal probability. If the first lamp is selected to be turned on, the scan chassis scans a chart to obtain a first scanning result, so as to determine whether the brightness of the first scanning result is higher than a predetermined value or not. To be noted, the predetermined value is such as 50% or 70% of the brightness of the original lamp. If the brightness of the scanning result is higher than the predetermined value (i.e. it is qualified), the scanning document is started. Otherwise, if the brightness of the scanning result is lower than the predetermined value (i.e. it is not qualified), the first lamp is turned off and the second lamp is turned on.

Then, after the second lamp is turned on, the scan chassis scans the chart again to obtain a second scanning result, so as to determine whether the brightness of the second scanning result is higher than the predetermined value or not. If the brightness of the scanning result is higher than the predetermined value (i.e. it is qualified), the scanning document is started. Otherwise, if the brightness of the scanning result is lower than the predetermined value (i.e. it is not qualified), the first lamp and the second lamp are turned on simultaneously.

After the first lamp and the second lamp are turned on simultaneously, the scan chassis scans the chart again to obtain a third scanning result, so as to determine whether the brightness of the third scanning result is higher than the predetermined value or not. If the brightness of the scanning result is higher than the predetermined value (i.e. it is qualified), the scanning document is started. Otherwise, if the brightness of the scanning result is lower than the predetermined value (i.e. it is not qualified), the user is then notified to replace the first lamp and the second lamp. The embodiments mentioned above only use the example of selecting the first lamp. However, the case where the scan device randomly selects the second lamp is similar to the case where the scan device randomly selects the first lamp. The details can be referred to in FIG. 4 and are not described herein again.

Certainly, the present invention is not limited to the style of one lamp holder mapping to one lamp as shown in the embodiment mentioned above. Optionally, the style of one lamp holder mapping to multiple lamps, or the style of multiple lamp holders mapping to multiple lamps are also acceptable. The method for turning on the lamp is as follows: At first, a scan chassis is provided. The scan chassis comprises a plurality of lamps, a reflection mirror set, an optical lens set, and an image capturing device. Wherein, each of the lamps can provide a light with a predetermined brightness to a document. Then, one of the lamps is randomly selected and turned on, and a chart is scanned to obtain a scanning result. Then, it is determined whether the brightness of the scanning result is higher than a predetermined value or not. If it is, the scanning document is started. Otherwise, when the brightness of the scanning result is lower than the predetermined value, another lamp of the lamps is selected and turned on.

Further, when the brightness of the scanning result is lower than the predetermined value, a step of scanning the chart so as to obtain a scanning result and determining whether the brightness of the scanning result is higher than the predetermined value or not is repeatedly performed.

Finally, when all lamps mentioned above are selected and all brightness of the scanning results obtained from using the lamps to scan are lower than the predetermined value (i.e. these lamps are all treated as failed), all lamps can be turned on simultaneously or only some lamps are turned on, so as to obtain enough brightness and to further enhance the life of the scan chassis.

Accordingly, the operation limit of the scan chassis of the present invention is not only a summation of the life of single equivalent lamp. The life of the scan chassis can be enhanced in the case where multiple sets of the failed lamps are all turned on simultaneously or only some of the failed lamps are turned on.

In summary, the scan device and the method for enhancing the life of the same at least has the following advantages.

1. The present invention can significantly enhance the life of the scan chassis.

2. The present invention can use a general lamp rather than the long life lamp, thus the cost is reduced.

3. The present invention can maintain a fixed brightness, and it very stable, thus it can maintain a good scanning quality.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A scan device, suitable for scanning a document, comprising:
a scan chassis, wherein the scan chassis comprises at least one light source module, and the light source module comprises a lamp holder and a plurality of lamps, wherein the plurality of lamps are disposed inside the lamp holder, and each of the lamps can provide a light with a predetermined brightness to the document;
a random selecting device, electrically coupled to the scan chassis, and used to randomly select and turn on one of the plurality of lamps in the scan chassis;
a brightness judging device, electrically coupled to the scan chassis; and
a chart, disposed above the scan chassis.

2. The scan device of claim 1, wherein the scan chassis comprises:
a chassis cover, wherein the light source module is disposed on the chassis cover;
a reflection mirror set, disposed inside the chassis cover, and located on a light path behind the document;
an optical lens set, disposed inside the chassis cover, and located on the light path behind the reflection mirror set; and
an image capturing device, disposed inside the chassis cover, and located on the light path behind the optical lens set.

3. The scan device of claim 2, wherein the chassis cover has an opening, and the light arrives at the reflection mirror set via the opening after it is reflected from the document.

4. The scan device of claim 2, wherein the image capturing device comprises a CCD.

5. A scan device, suitable for scanning a document, comprising:
a plurality of light source modules, wherein each of the plurality of light source modules comprises a lamp holder and a lamp, the plurality of lamps are disposed inside the plurality of lamp holders respectively, and each of the lamps can provide a light with a predetermined brightness to the document;
a random selecting device, electrically coupled to the scan chassis, and used to randomly select and turn on one of the plurality of lamps in the scan chassis;
a brightness judging device, electrically coupled to the scan chassis; and
a chart, disposed above the scan chassis.

6. The scan device of claim 5, wherein the scan chassis comprises:
a chassis cover, wherein the light source module is disposed on the chassis cover;
a reflection mirror set, disposed inside the chassis cover, and located in a light path behind the document;
an optical lens set, disposed inside the chassis cover, and located in the light path behind the reflection mirror set; and
an image capturing device, disposed inside the chassis cover, and located in the light path behind the optical lens set.

7. The scan device of claim 6, wherein the chassis cover has an opening, and the light arrives at the reflection mirror set via the opening after it is reflected from the document.

8. The scan device of claim 6, wherein the image capturing device comprises a CCD.

9. A method for enhancing a life of a scan device, comprising:
providing a scan chassis, wherein the scan chassis comprises a plurality of lamps, a reflection mirror set, an optical lens set, and an image capturing device, and each of the lamps can provide a light with a predetermined brightness to a document; and
randomly selecting and turning on one of the lamps.

10. The method for enhancing the life of the scan device of claim 9, wherein the lamps comprise a first lamp and a second lamp.

11. The method for enhancing the life of the scan device of claim 10, further comprising:
turning on the first lamp;
scanning a chart so as to obtain a first scanning result; and
determining whether the brightness of the first scanning result is higher than a predetermined value or not, if it is, starting the scanning, and if the brightness of the scanning result is lower than the predetermined value, turning off the first lamp and turning on the second lamp.

12. The method for enhancing the life of the scan device of claim 11, wherein after turning on the second lamp, further comprises:
scanning the chart so as to obtain a second scanning result; and
determining whether the brightness of the second scanning result is higher than the predetermined value or not, if it is, starting the scanning, and if the brightness of the scanning result is lower than the predetermined value, turning on the first lamp and the second lamp simultaneously.

13. The method for enhancing the life of the scan device of claim 12, wherein after turning on the first lamp and the second lamp simultaneously, further comprises:
scanning the chart so as to obtaining a third scanning result; and
determining whether the brightness of the third scanning result is higher than the predetermined value or not, if it is, starting the scanning, and if the brightness of the scanning result is lower than the predetermined value, notifying the user to replace the lamps.

14. A method for enhancing a life of a scan device, comprising:
(a) providing a scan chassis, wherein the scan chassis comprises a plurality of lamps, a reflection mirror set, an optical lens set, and an image capturing device, and each of the lamps can provide a light with a predetermined brightness to a document; and
(b) randomly selecting and turning on one of the lamps
(c) scanning a chart so as to obtain a scanning result; and
(d) determining whether the brightness of the scanning result is higher than a predetermined value or not, if it is, starting the scanning, and if the brightness of the scanning result is lower than the predetermined value, selecting and turning on another of the lamps.

15. The method for enhancing the life of the scan device of claim 14, wherein after performing the step (d), further comprises executing at least one time of the steps (c) to the step (d).

16. The method for enhancing the life of the scan device of claim 14, wherein when all the lamps are selected and the brightness of the scanning result obtained by using the lamps to scan are all lower than the predetermined value, all the lamps are turned on simultaneously.

17. The method for enhancing the life of the scan device of claim 14, wherein when all the lamps are selected and the brightness of the scanning results obtained by using the lamps to scan are all lower than the predetermined value, some of the lamps are turned on simultaneously.
